(19) United States
(12) Patent Application Publication
(10) Pub. No.: US 2009/0075226 A1
(43) Pub. Date: Mar. 19, 2009

(54) ORTHODONTIC BRACKETS

(76) Inventors: Yoshiki Oshida, DeWitt, NY (US); Masahiko Itakura, Yokohama (JP); Tatsuya Nakata, Himeji - City (JP)

Correspondence Address: LAW OFFICES OF EUGENE M. CUMMINGS, P.C., ONE NORTH WACKER DRIVE, SUITE 4130, CHICAGO, IL, 60606, US

(21) Appl. No.: 12/201,159

(22) Filed: Aug. 29, 2008

Related U.S. Application Data
(60) Provisional application No. 60/994,178, filed on Sep. 18, 2007.

(51) Int. Cl. A61C 7/14

(52) U.S. Cl. 433/8

(57) ABSTRACT

Polymeric resin matrix phase (thermoplastic, thermosetting or biomass) is reinforced with fiber filament or fine particles to enhance the mechanical properties (particularly, bending strength and bending stiffness), impact strength while keeping its original transparency. Plastic brackets (either previously reinforced as mentioned above or un-reinforced) can be surface-treated by plasma coating with thin film or simply ultra violet radiation to enhance the surface mechanical properties as well as anti-frictional force against the archwire's movement while again maintaining its transparency. Accordingly, the present invention can provide orthodontic brackets made of plastics with high mechanical strengths and clearness, so that aesthetic appearance is improved.

### CROSS REFERENCE TO RELATED APPLICATIONS

This application claims benefit under 35 U.S.C. §119(e) of U.S. Provisional Application entitled “Orthodontic Brackets”, filed on Sep. 18, 2007, assigned application No. 60/994,178 and naming Yoshiki Oshida, Masahiko Itakura and Tatsuya Nakata as inventors. The complete disclosure thereof being incorporated by reference herein.

### FIELD OF THE INVENTION

This invention relates, in general, to a dental appliance, and more specifically an orthodontic bracket that has excellent clearness and mechanical strength, very good biocompatibility, excellent aesthetic appearance, a high ratio of relative strength and stiffness to weight, and an environmentally friendly product when brackets are disposed if manufactured from a certain type of biomass polymeric materials.

### BACKGROUND OF THE INVENTION

Generally, orthodontic appliances are composed of two major devices: reactive brackets and active archwires. Brackets are considered reactive appliances since their function is concentrated on physical holding in place a force (particularly a torque force) generating active appliance such as an archwire. An occurrence of mechanical and physical recovery force of the archwire can result in tooth movement, performing orthodontic mechano-therapeutic treatment effectively and efficiently. There are several requirements for brackets to perform successful biofunction and orthodontic mechano-therapy. They should include: (1) firm bonding strength to tooth enamel structure, (2) slot portions, where the active archwire is always sliding with a small amount of distance which should possess low values of static and kinetic friction coefficients against archwire materials (which are normally made of stainless steel, Ti—Ni, Ti—Ni containing Mo or Cu elements), (3) sufficiently high mechanical properties (particularly bending strength as well as bending modulus), (4) reasonably high fracture strength, and (5) a clear appearance. The last requirement reflects to a current trend, and it is recognized that patients increasingly have demanded orthodontic appliances which are less noticeable and more visually appealing than traditional metal appliances.

Orthodontic brackets have been typically manufactured from three different types of materials. For example, some brackets are made of metallic materials such as stainless steel as disclosed in U.S. Pat. Nos. 4,536,154 and 4,659,309, or titanium materials as disclosed in U.S. Pat. No. 5,232,361. The second choice group for bracket materials is ceramics as disclosed in U.S. Pat. Nos. 4,954,080, 5,011,403, and 5,071,344. Certain types of plastics have been selected as bracket materials as disclosed in U.S. Pat. No. 4,536,154; or plastic-matrix composites (principally, glass fiber reinforced polycarbonates) as disclosed in U.S. Pat. No. 5,078,596 or U.S. Pat. No. 5,254,002. These nine aforementioned patents are hereby incorporated by reference herein.

It has been estimated that there are approximately 80 to 100 million brackets clinically used per year in the world. The metal brackets occupy about 90% of such 80˜100 million brackets and the remaining 10% are shared equally between both ceramic and plastic brackets. Because of the advantageous appearance associated with ceramic and plastic brackets, the above mentioned ratio between metal and ceramic/plastic brackets can be different and accordingly, the ratio of ceramic/plastic brackets are much higher in countries such as the U.S.A. or Japan than other countries.

While there does not exist an almighty material in any sectors of materials' serving fields, including both engineering applications and medical/dental clinical applications, it is true that current materials being used will possess both advantages and disadvantages. And, with metallic orthodontic devices, without exceptions, there are advantages and disadvantages. In particular, the following advantages are normally recognized: (1) because of relatively high mechanical strengths, there is a small deformation or fracture due to occlusal and/or orthodontic forces, (2) because of relatively low frictional coefficient, tooth movement can be easily achieved, (3) plaque accumulation, discoloration, or food debris can be easily detected, and (4) they are relatively inexpensive.

On the other hand, there are several disadvantages associated with metal brackets: (1) devices appear very noticeable, (2) natural dentin might be worn when such metallic brackets are in contact, and (3) allergic reaction can take place, depending on the sensitivity of patients. In addition to these demerits of metal brackets, there are even more serious concerns on metal brackets. For example, if such brackets are physically in contact with archwire which is made of different type of materials (for example, stainless steel bracket with Ti—Ni archwire), and these dissimilar materials are exposed to saliva solution; as a result, the so-called galvanic corrosion cell can be established between these dissimilar materials. Depending on the immersion potential value, the less noble material is prone to be easily dissolved. In many cases, the extent of such galvanic corrosion can be more severe than the case when the less noble material is not coupled with noble material. This dissimilar metal couple is also not favorable in terms of the kinetic friction coefficient, ranging from 0.140 (stainless steel bracket with stainless steel archwire), 0.163 (stainless steel bracket with Co—Cr archwire), 0.337 (stainless steel bracket with Ti—Ni archwire) to 0.357 (stainless steel bracket with beta-Ti archwire) [R. P.Kusy et al., Am J Orthod Dentofac Orhtop, 1990;98:300-312]. There is also crucial concern for the metal brackets. For example, among adult patients wearing orthodontic brackets, 20˜25% of the population may require surgery of some sort during orthodontic mechano-treatment. Materials, particularly those that contain an iron element, are magnetic and referred to as ferromagnetic materials. When brackets are comprised of such ferromagnetic materials, they interfere with MRI and CT imaging by creating scatter. Hence, certain types of metallic brackets (except Titanium brackets) are not MRI compatible.

With clear brackets (made of, in general, ceramics or plastics), the aforementioned advantages associated with metal brackets can be their disadvantages while the metals' disadvantages can be ceramic/plastic brackets' advantages. Normally, bracket devices are not easily noticed, and there are no causes for metal allergic actions. However, accumulated plaque or food debris can not be easily detected and these brackets are relatively low toughness or rigidity against the fracturing process.

Chemical retention of the ceramic bracket base to the adhesive is generally facilitated by a coating of silica and silane coupling agent. The resultant chemical bond is very strong and may cause the enamel/adhesive interface to be stressed during either the debonding process or an impact or sudden occlusal force. Hence, irreversible damage to the healthy underlying enamel tooth structure of the entire tooth may occur and is particularly significant when bonding endotontically treated teeth or teeth with large restorations. In addition, due to the hardness of ceramic brackets, abrasion during the chewing process can lead to enamel abrasive wear. Ceramic brackets are extremely brittle and even the smallest cracks (flaws) can dramatically reduce that load required for fracture; in other words, very low value of the fracture toughness [G. E.Scott, The Angle Orthodontics, 1988;58:5-8]. Brackets that distort or fail during the treatment render tooth movement ineffective and inefficient, and minimize control of tooth movement, resulting in an unnecessary extending treatment time.

Brackets fabricated from polymeric materials (for example, polycarbonate; PC) demonstrate distortion under torsional loading generated by orthodontic archwires, and possesses a high propensity for water absorption [Y.Oshida, et al., Biomed Mater & Eng., 1999;9:125-133], which may result in discoloration of the bracket and undesired staining. Water sorption causes not only the appearance but also adversely affects mechanical properties and provides uncertain dimensional stability as well [Y. Oshida, et al., Biomed Mater & Eng., 1994;4:397-407].

In addition, there are several problems with certain types of polymeric material, particularly, polycarbonate (PC) with high degree of clearness. Firstly, PC materials possess an adverse propensity toward the discoloration by pigment contained in food and beverage. The second issue is related to the BPA dissolution. Bisphenol A (BPA) is a monomer with estrogenic activity (or recognized as endocrine distrupters) that is used in the production of food packaging, dental sealants, polycarbonate plastic, and many other products [F.Ohtake et al., Nature, 2003;423:545-550]. The monomer has previously been reported to hydrolyze and leach from these products under high heat and alkaline conditions, and the amount of leaching increases as a function of use. PC (polycarbonate) has been employed as a typical polymeric material for clear orthodontic brackets, which is manufactured using BPA. By the animal tests, it was reported that significant estrogenic activity, identifiable as BPA, was released from used polycarbonate animal cages [K. L.Howdeshell et al., Environ Health Perspect, 2003; 111:11 80-1187]. These factors limit the use of such brackets in the oral environment.

Answering the ever-growing demand for transparent orthodontic brackets, a certain type of polymeric materials or reinforced polymers may be the best material choice. As mentioned previously, there are several crucial requirements for successfully performing orthodontic brackets. These requirements should include, at least: (1) bonding to the enamel tooth structure sufficiently, (2) good mechanical strengths and stiffness, (3) excellent aesthetic appearance, and (4) good biocompatibility to intraoral hard and soft tissues. However, we should add, at least, one more requirement to these lists. As mentioned previously, there are roughly 80 to 100 million brackets clinically used every year. On average, one orthodontic mechano-treatment lasts for 12 to 15 months. Upon completion of such treatment, all bonded brackets are removed from enamel surfaces and discarded. Because of small dimensions of these brackets (regardless of the type of materials), it is hard to recycle. It is also anticipated that recovery rate will be very low. Although the sharing ratio of plastic brackets within 80 to 100 million brackets is still small, in some countries (for example, the U.S.A. or Japan) this sharing ratio is expected to be much higher. Wasting or simple damping such plastic materials is very harmful to environmental health, as discussed previously. Hence, it is necessary to add one more requirement to the aforementioned list, and that is (5) environment-friendliness.

Carbon neutrality refers to the practice of balancing carbon dioxide released into the atmosphere from burning fossil fuels, with renewable energy that creates a similar amount of useful energy, so that the net carbon emissions are zero. Conventional types of plastics, originated from petroleum, can not be decomposed, causing environmental pollution and hazardousness. Ever-growing social demands on environmental compatibilities, plastics which are originated from natural resources, have been developed and advanced. Such plastics are called biomass (or biodegradable) plastics, which can be made from plants including corn, sugarcane, potato, rice, etc. Biomass plastics can be completely decomposed to lower molecular substances of water and carbon dioxide. Hence, if such biomass plastics are burned, carbon neutrality can be maintained.

A typical process for biomass plastics production is simple; natural plant resources (corn, sugarcane, potato, rice, etc.)→starch→fermentation/polymerization→poly(L-lactide): PLLA→biodegradable plastic products. In this specification, applications of biomass PLLA have been proposed and disclosed.

Bending modulus can be within a range between 4,000 MPa and 20,000 MPa, whilst preferably it can be in a range between 6,000 MPa and 18,000 MPa; more specifically within a range from 8,000 MPa to 14,000 MPa.

### OBJECTS AND SUMMARY OF THE INVENTION

It is an object of the present invention to provide an orthodontic bracket with high strength and high modulus (therefore, stiffness) which can relatively readily deform elastically (i.e., not deform permanently) to more easily accommodate functional appliances such as orthodontic archwires with large cross sections.

It is a further object of the present invention to provide an orthodontic bracket with reasonable degree of transparency. It is yet a further object of the present invention to provide an orthodontic bracket which possesses biological and environmental compatibilities.

### BRIEF DESCRIPTION OF THE DRAWINGS

The above and many other objects, features and advantages of this invention will be fully understood from the ensuring detailed description of the preferred embodiment of the invention, which should be read in conjunction with the accompanying drawings wherein:

FIG. 1 is a front perspective view of an orthodontic bracket according to the present invention.

FIG. 2 is a front perspective view of an orthodontic bracket as in FIG. 1, coupled with an orthodontic archwire (a portion of the archwire is shown).

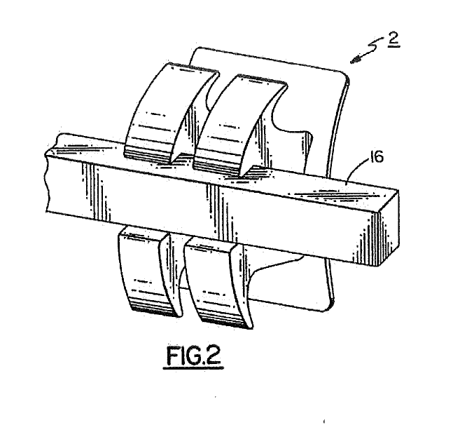

### DETAILED DESCRIPTION OF THE INVENTION

In the preferred embodiment of the present invention, a bracket was made of plastic materials having a reasonable strength, stiffness, toughness, and transparency.

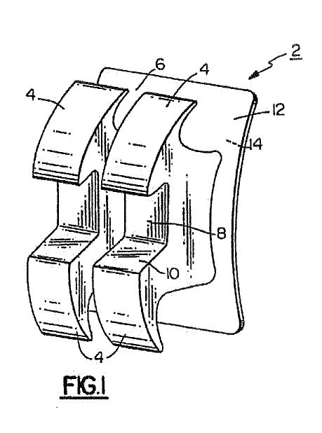

Referring to now FIG. 1, there is shown a bracket 2 having a pair of spaced apart tie wings 4 extending outwardly from a base portion 12. The space between the tie wings is a cross cut portion 6. One tie wing is the mesial tie wing having gingival and occlusal sides, and the other is the distal tie wing having gingival and occlusal sides. A pair of archwire slots are defined as openings between the gingival and occlusal sides of each tie wing 4; each slot has a bottom portion 10. The base portion 12 has two side faces, with the tie wings formed on a convex surface side, while a rear concave surface side or a tooth contact surface 14 is designed to be bonded to a dental enamel surface with an appropriate bonding agent.

To such structured bracket 2 serving as a reactive (fixed) appliance, an orthodontic archwire 16 (with either round or rectangular cross section and made of either stainless steel, titanium alloys, or titanium-nickel alloy) is inserted into a slot opening portion 8, serving as an active (functioning) appliance to provide directional forces resulting in tooth movement.

For reinforcing plastic matrix, there are many methods proposed. Although there are various proposed methods to reinforcing matrix phases of ceramics or plastics, the common factor among these methods is how to reduce the energy which the propagating crack is carrying. If any mechanisms are successful to reduce such kinetic energy, the advancing crack must arrest prior to restore energy large enough to propagate further, or stop completely at the place where the advancing crack encounters any energy-dissipating obstacles. Accordingly, a cracking (fracturing) can be controlled. The micromechanics that lead to improved fracture resistance in such materials can include; (a) transformation toughening, (b) microcrack toughening, (c) crack deflection, (d) fiber/whisker toughening, (e) bridging toughening, (f) shielding effect toughening, and (g) ductile phase toughening [D. Hull, An Introduction to Composite Materials, Cambridge Press, England, 1982; Translated by H. Miyairi et al., Baufuukan, Tokyo 1983, pp. 181-219] [T. Sakuma, Ceramic Materials Science, Kaibundo, Tokyo, 1990; pp. 177-196]. (a) Transformation toughening; zirconium dioxide experiences a stress-induced martensitic transformation from FCC tetragonal crystalline structure to BCC monoclinic crystalline structure, resulting in a shear deformation and a volume change (i.e., a dilatational strain); thereby materials incorporated with such oxides often have improved toughness by consuming cracking energy by conversion of crystalline phase transformation. (b) Microcrack toughening; although the formation of cracks in a material is generally deleterious, microcracking can sometimes lead to improved toughness, since microcracks can serve as a crack arrester to release stored strain energy. (c) Crack deflection; if particles—round shaped with a less stress intensity factor—are included in matrix phase, an advancing crack will defect when it reaches these obstacles, releasing stored strain energy. (d) Fiber/whisker toughening; one of the most interesting features of composites (particularly, ceramic composites) is that the combination of a brittle ceramic matrix with brittle ceramic fibers or whiskers can result in a materials relatively high toughness. The secret to the high toughness of ceramic composites lies in the bond between the matrix and the fibers or whiskers, and it is normally believed that a brittle interface can lead to higher toughness than a strong interface. (e) Bridging toughening; instead of having an obstacle dispersed in the matrix phase, particles are included to dissipate the stored strain energy while the bridging particles are fracturing under a steady rate of crack propagation. (f) Shielding effect toughening; cracks can be shielded under the residual compressive stress, so that the crack propagation can be controlled. In this well-known technique, ion exchanging toughening is applied in dental porcelain only on the surface layer, by exchanging the parent smaller ion (Ca or Na) ion by larger ion (K) to produce surface compressive residual stress (ca. 700 MPa, based on 35% ion diameter difference). (g) Ductile phase toughening; ceramics alloyed with ductile particles exhibit both bridging and process zone toughening. Plastic deformation of the particles in the process zone contributes to toughness.

Although the aforementioned techniques to improve mechanical performances, particularly toughness and controlling the advancing crack, have been successfully introduced and applied in industrial engineering field, it is noticed that there are limitations to apply these reinforcing techniques directly to orthodontic brackets reinforcing and fabrication. Such limitations can come from the facts that (1) dimension is relatively small, and (2) some portion of the bracket structure does not possess uniform wall thickness. Accordingly, uniformity of distribution of such reinforcing particles (either fiber form or powder form) is a challenging task, and such uniformity is strongly related to particle size and shape.

The overall strength of a fiber-reinforced composite depends not only on the tensile strength of the fibers, but, in addition, on the degree to which an applied load is transmitted to the fibers. The extent of this load transmittance is a function of fiber length and the magnitude of the fiber-matrix interfacial bond. Under an applied stress, this fiber-matrix bond ceases at the fiber ends, yielding a matrix deformation pattern. In other words, there is no load transmittance from the matrix at the fiber extremity. This load supported by a fiber depends on position. The load is constant, except for end region, where it tapers off to zero. Thus, as fiber length increases, the more effective the reinforcement of the matrix by the fiber phase. For extremely short fibers there is very little reinforcement, since this end effect spans the entire fiber length. The critical fiber length that is necessary for effective strengthening of the composite material is dependent on fiber diameter, its ultimate strength, and the interfacial fiber-matrix bond strength. This critical length for many fiber-matrix combinations lies between 10 and 100 times the fiber diameter [T.Fujii and M.Zako, Fracture and Mechanics of Composite Materials, Jikkyo Pub., Tokyo, 1978; pp. 85-119]. In other words, the critical aspect ratio (fiber length 1/fiber diameter d_{F}) should be between 10 and 100. Fibers that are significantly longer than this critical length are termed continuous, while discontinuous fibers have lengths shorter than this critical value. For discontinuous fibers of lengths significantly less than the critical, the matrix deforms around the fiber such that there is virtually no stress transference, and little reinforcement by the fiber. Strengthening of a composite by discontinuous fibers is based on the principle that a matrix can transfer a load to short fibers via shear forces along the matrix/fiber interface. It is assumed that the short fibers are uniformly packed and aligned and the fibers and matrix are strained equally at the interface. To support the load, the shear strength of the fiber/matrix bond (τ) times the area of the fiber/matrix bond must be equal to or greater than the tensile strength of the fiber (σ_{F}) times the cross-sectional area of the fiber. That is, τ×πd_{F}1>σ_{F}×π/4×d_{F}² which yields to 1/d_{F}>σ_{F}/4τ. Therefore, if the bond strength and fiber strength are known, only certain values of 1/d_{F} (aspect ratio=fiber length 1/ fiber diameter d_{F}), will satisfy the equations. If the aspect ratio is too low, that is usually if the fiber is too short, the load will not be supported and the strength of the composite will be greatly reduced.

So far, we have been discussing two important parameters governing the reinforcement of plastic matrix materials; particle size/shape and aspect ratio of fiber. There should be, at least, one more parameter when the strengthened plastic brackets are used as orthodontic brackets, particularly when they are attached on front teeth. This third parameter should be transparency for clear appearance. With the aforementioned reinforced plastics, if the original clearness is required to be maintained to some extent, there are basically two methods available: (1) use a small size of reinforcing material (either particle or fiber) and such size should be equal to or small than the visual light wavelengths (ranging from 330 to 770 nanometer), and/or (2) equalize the index of refraction of reinforcing material to that of matrix material.

Composition 1

Acrylonitorile-styrene copolymer AS (Product: AS CEVIAN-N050; Daicel Polymer, Ltd., Tokyo Japan) 90 weight % was mixed with reinforcing glass fiber T351 (Product: ECS03 T-351; Nippon Electric Glass, Ltd., Tokyo Japan) 10 weight %. Polymeric resin material from the poly-styrene groups was chosen based on the fact that polystyrene along polypropylene or polyolefin are chemically stable and do not have dissolution problems of additives or environmental hormone. The mixing was done by melting/kneading AS copolymer by a dual-axial extrusion machine (TEX 30; Nihon Seioko Ltd., Tokyo Japan) with the cylinder temperature of 230° C. while the above-mentioned glass fiber was supplied through the side-feeder to produce pellets. The thus produced pellets were injection-molded to produce test pieces. The injection molding was done using the injection molding machine (Injection Molding Machine SH100, Sumitomo Heavy Industries, Ltd., Ohsaka Japan) with the cylinder temperature of 240° C. and the metal mold temperature of 60° C. The test piece was then subjected to mechanical and physical tests. Bending strength and bending modulus were obtained by TENSILON UTM-5T (Toyo Bowldwin Co. Ltd., Tokyo Japan) per ISO 178 specification. The notched Charpy impact tests were conducted by the Charpy Impact Tester DG-CB (Toyo Seiki Seishaku-Syo, Ltd., Tokyo Japan) per ISO 179/1eA specification. The total light transmittance tests and refractive index tests were conducted by the Automatic Haze Meter TC-H III DP (Tokyo Densyoku Co. Ltd., Tokyo Japan) per ISO 489 and ISO 13468-1, respectively. All aforementioned mechanical and physical evaluations were performed on five identical test pieces. The average value over 5 data points were calculated along with the standard deviation. The total light transmittance was measured on sample thickness of 3 mm. All tests were conducted at room temperature. Results of Composition 1 are listed below, where average values are shown with standard deviation listed inside the ( ) marks.

Results of Composition 1 (90 wt. % AS + 10 wt. % T351)

| properties | unit | AS | T351 | Composition 1 |
|---|---|---|---|---|
| Bending strength | MPa | 120 | | 121.08 (0.65) |
| Bending modulus | MPa | 3600 | * | 5406.56 (25.35) |
| Notched Charpy strength | kJ/m² | 2 | | 3.84 (0.25) |
| Total light transmittance | % | 90 | | 85.28 (1.21) |
| Refractive index | | 1.57 | 1.56 | |

*: about 700GPa for tensile modulus

Composition 2

Acrylonitorile-styrene copolymer AS 80 weight % was mixed with reinforcing glass fiber T351 20 weight %. The mixing and molding were done by the exact same procedures as described for Composition 1. Mechanical and optical properties were evaluated by the exact same procedures using the same equipment as the Composition 1. Results of Composition 2 are listed below, where average values are shown with standard deviation listed inside the ( ) marks.

Results of Composition 2 (80 wt. % AS + 20 wt. % T351)

| properties | unit | AS | T351 | Composition 2 |
|---|---|---|---|---|
| Bending strength | MPa | 120 | | 151.4 (1.52) |
| Bending modulus | MPa | 3600 | | 7525.18 (18.14) |
| Notched Charpy strength | kJ/m² | 2 | | 5.06 (0.21) |
| Total light transmittance | % | 90 | | 76.64 (0.57) |
| Refractive index | | 1.57 | 1.56 | |

Composition 3

Acrylonitorile-styrene copolymer AS 70 weight % was mixed with reinforcing glass fiber T351 30 weight %. The mixing and molding were done by the exact same procedures as described for Composition 1. Mechanical and optical properties were evaluated by the exact same procedures using the same equipment as the Composition 1. Results of Composition 3 are listed below, where average values are shown with standard deviation listed inside the ( ) marks.

Results of Composition 3 (70 wt. % AS + 30 wt. % T351)

| Properties | unit | AS | T351 | Composition 3 |
|---|---|---|---|---|
| Bending strength | MPa | 120 | | 161.76 (1.51) |
| Bending modulus | MPa | 3600 | | 10300.94 (22.12) |
| Notched Charpy strength | kJ/m² | 2 | | 5.12 (0.26) |
| Total light transmittance | % | 90 | | 66.02 (0.88) |
| Refractive index | | 1.57 | 1.56 | |

Composition 4

Thermoplastic cyclo-olefin copolymer TCOC (Product: TOPAS 5013; Daicel Polymer, Ltd., Tokyo Japan) 90 weight % was mixed with inorganic glass reinforcing fiber T480 (Product: ECS03 T-351; Nippon Electric Glass, Ltd., Tokyo Japan) 10 weight %. The main difference between T351 (which was used for previous Compositions 1 through 3) and T480 (which are used in the following Compositions 4 through 6) is based on the type of surface treatment on glass fiber for enhancing the bonding strength of fiber filament to the polymeric resin matrix phase. The T351 glass fiber was surface-treated suitable for the styrene polymers, while T480 glass fiber was surface-treated suitable for the olefin polymers. The mixing and molding were done by the exact same procedures as described for previous Compositions. Mechanical and optical properties were evaluated by the exact same procedures using the same equipment as previous Compositions. Results of Composition 4 are listed below, where average values are shown with standard deviation listed inside the ( ) marks.

Results of Composition 4 (90 wt. % TCOC + 10 wt. % T480)

| properties | unit | TCOC | T480 | Composition 4 |
|---|---|---|---|---|
| Bending strength | MPa | 90 | | 105.92 (3.32) |
| Bending modulus | MPa | 2700 | * | 4817.50 (51.74) |
| Notched Charpy strength | kJ/m² | 1.6 | | 5.06 (0.21) |
| Total light transmittance | % | 91 | | 80.04 (1.03) |
| Refractive index | | 1.53 | 1.56 | |

*: about 700GPa for tensile modulus

Composition 5

Thermoplastic cyclo-olefin copolymer TCOC 80 weight % was mixed with inorganic glass reinforcing fiber T480 20 weight %. The mixing and molding were done by the exact same procedures as described for previous Compositions. Mechanical and optical properties were evaluated by the exact same procedures using the same equipment as the Composition 1. Results of Composition 5 are listed below, where average values are shown with standard deviation listed inside the ( ) marks.

Results of Composition 5 (80 wt. % TCOC + 20 wt. % T480)

| properties | unit | TCOC | T480 | Composition 5 |
|---|---|---|---|---|
| Bending strength | MPa | 90 | | 120.72 (2.30) |
| Bending modulus | MPa | 2700 | | 6803.78 (10.38) |
| Notched Charpy strength | kJ/m² | 1.6 | | 6.20 (0.19) |
| Total light transmittance | % | 91 | | 50.60 (0.86) |
| Refractive index | | 1.53 | 1.56 | |

Composition 6

Thermoplastic cyclo-olefin copolymer TCOC 70 weight % was mixed with inorganic glass reinforcing fiber T480 30 weight %. The mixing and molding were done by the exact same procedures as described for previous Compositions. Mechanical and optical properties were evaluated by the exact same procedures using the same equipment as the Composition 1. Results of Composition 6 are listed below, where average values are shown with standard deviation listed inside the ( ) marks.

Results of Composition 6 (70 wt. % TCOC + 30 wt. % T480)

| Properties | unit | TCOC | T480 | Composition 6 |
|---|---|---|---|---|
| Bending strength | MPa | 90 | | 141.68 (2.18) |
| Bending modulus | MPa | 2700 | | 9305.80 (16.34) |
| Notched Charpy strength | kJ/m² | 1.6 | | 6.18 (0.22) |
| Total light transmittance | % | 91 | | 31.56 (0.72) |
| Refractive index | | 1.53 | | |

As mentioned previously, the refractive index of reinforcing filament should be close as possible to that of matrix phase in order to maintain the original transparency of the plastic matrix phase. Let N_{P} be the refractive index of the plastic matrix and N_{F} be the refractive index of reinforcing fiber filament. Hence, it is ideal that |N_{P}−N_{F}| should be close to zero. The following table compares the absolute value of differences in refractive indices between two materials for all previous six Compositions, indicating that all Compositions show the satisfactory level of the value of the absolute difference between two indices |N_{P}−N_{F}|.

| | Composition 1 | Comp. 2 | Comp. 3 | Comp. 4 | Comp. 5 | Comp. 6 |
|---|---|---|---|---|---|---|
| \|N_{P} − N_{F}\| | 0.01 | 0.01 | 0.01 | 0.03 | 0.03 | 0.03 |

Besides these matrix materials used on the aforementioned compositions, there can be still include polystyrene (1.59-1.60), polyamide (1.53), polypropylene (1.49) and polymethyl methacrylate (1.49).

Composition 7

With regard to the aspect ratio (a ratio of fiber length divided by fiber diameter), glass fiber which were used for Compositions 1 through 3 (T351) and Compositions 4 through 6 (T480) possesses average diameter of 13 μm and 400-500 μm as average weight length. To evaluate the effects of aspect ratio of the reinforcing glass fiber on plastic matrix, the loading of the fiber was chosen as 70 weight % since Compositions 3 and 6 exhibited the highest mechanical properties for each glass fiber group (i.e., T351 and T480). Using T351 fiber, three groups of aspect ratios (AR) were prepared before mixing to AS plastic matrix phase; (1) average aspect ratio of 30 or higher, and (2) average aspect ratio 15 or less. All mechanical and physical tests were conducted under the exact same procedures and specifications as previous tests for Compositions 1 through 6. Results of Composition 7 are listed in the following table with averaged value along with the standard deviation with ( ) marks.

Results of Composition 7. 70 wt. % AS + 30 wt. %
T351 with three aspect ratios (AR)

| Properties | unit | AR > 30 | AR < 15 |
|---|---|---|---|
| Bending strength | MPa | 162.79 (1.54) | 132.14 (1.46) |
| Bending modulus | MPa | 10307.02 (23.15) | 6818.11 (18.11) |
| Notched Charpy strength | kJ/m² | 5.13 (0.24) | 4.51 (0.25) |
| Total light transmittance | % | 68.03 (0.91) | 73.15 (1.23) |

Composition 8

Using T480 fiber, three groups of aspect ratios (AR) were prepared before mixing to TCOC plastic matrix phase; (1) average aspect ratio of 30 or higher, and (2) average aspect ratio 15 or less. All mechanical and physical tests were conducted under the exact same procedures and specifications as previous tests for Compositions 1 through 6. Results of Composition 8 are listed in the following table with averaged value along with the standard deviation with ( ) marks.

Results of Composition 8. 70 wt. % TCOC + 30 wt. %
T480 with three aspect ratios (AR)

| properties | unit | AR > 30 | AR < 15 |
|---|---|---|---|
| Bending strength | MPa | 140.87 (2.11) | 113.25 (1.83) |
| Bending modulus | MPa | 9307.82 (16.03) | 5361.64 (19.10) |
| Notched Charpy strength | kJ/m² | 6.19 (0.23) | 5.23 (0.20) |
| Total light transmittance | % | 32.62 (0.77) | 43.52 (1.01) |

Accordingly, it was found that the usage of fiber filament with aspect ratio (AR) less than 15 was not effective for reinforcement, and AR should be equal or larger than 30.

As reinforcing filament, it has been described about usage of only glass fiber (T480 and T351, which are equivalent to E-glass). However, the type of fiber is not limited to the fiber used in aforementioned Compositions, it should include other types of fiber filaments if the following conditions are satisfied; (1) a relatively high aspect ratio, and (2) refractive index being similar to that of polymeric matrix phase. As candidate alternatives are potassium titanate filament, silicon nitride, alumina fiber, or alumina borate. For example, alumina borate (Al₂O₃ B₂O₃) (Aluborex, Shikoku Kasei Kogyo, Kawawa, Japan) possesses the refractive index of a range from 1.60 to 1.62 and aspect ratio of a range from 20 to 30. The refractive index (1.60 1.62) is found to be very close to that of PC polycarbonate (1.59). The advantageous effect of filler adding to the polymeric matrix phase should include not only the strengthening the mechanical properties, but also the enhancing the dimensional stability due to using material having low linear thermal expansion coefficient. This is true for not only fiber material, but for the fine-dispersive particles too, as will be described in the immediate following Compositions.

Composition 9

So far, this invention has been disclosed about various reinforcing methods for plastic materials which are originated from petroleum (in other words, fuel-originated plastics). Due to the ever-increasing social and environmental demands on anti-carbon dioxide issue, variety of plastics has been produced from natural plant sources such as corn, rice, potato, or the others. These plant-originated plastics are called as biomass plastics. The typical type of such biomass plastics is PLLA, which is poly (L-lactide). Due to the high crystallinity of PLLA, it has an excellent transparency. There are variety of PLLA which are commercially available, including Ecodeal (Toray, Ohsaka Japan) and Lacty (Shimadzu Seisakujo, Kyoto Japan).

Ninety weight % (90 wt. %) of Ecodeal pellet was admixed with, glass fiber T120 (Products: ECS03-T-120; Nippon Electric Glass, Ltd., Tokyo Japan) with 10 wt. %. All mechanical and physical tests were conducted under the exact same procedures and specifications as previous Compositions. Results of Composition 9 are listed in the following table with averaged value along with the standard deviation with ( ) marks.

Results of Composition 9 (90 wt. % PLLA + 10 wt. % T120)

| properties | unit | PLLA | Composition 9 |
|---|---|---|---|
| Bending strength | MPa | 77 | 113.55 (2.44) |
| Bending modulus | MPa | 3500 | 6030.10 (25.36) |
| Notched Charpy strength | kJ/m² | 2.4 | 4.60 (0.42) |
| Total light transmittance | % | 94 | 26.35 (0.89) |
| Refractive index | | 1.66 | |

Composition 10

Ninety-five weight % (95 wt. %) of Ecodeal pellet was admixed with T120 glass fiber with 5 wt. %. All mechanical and physical tests were conducted under the exact same procedures and specifications as previous Compositions. Results of Composition 10 are listed in the following table with averaged value along with the standard deviation with ( ) marks.

Results of Composition 10 (95 wt. % PLLA + 5 wt. % T480)

| properties | unit | PLLA | Composition 10 |
|---|---|---|---|
| Bending strength | MPa | 77 | 104.55 (2.44) |
| Bending modulus | MPa | 3500 | 4300.10 (25.36) |
| Notched Charpy strength | kJ/m² | 2.4 | 3.43 (0.42) |
| Total light transmittance | % | 94 | 40.35 (0.89) |
| Refractive index | | 1.66 | |

Composition 11

There are unique materials available to improve the impact strength to the polymeric resin after incorporating these materials the resin matrix phase. For example, there is a Paraloid (a product from Rohm and Haas) additives. This type of additive is structured by a core-shell type, in which core is made of rubbery materials such as butadiene or acrylic rubber to bear the impact loading and the shell is made of thermoplastics polymers such as polymethyl methacrylate PMMA, or polystyrene. Out of various trial for combination for mixing of resin matrix, reinforcing glass fiber and anti-impact additive, we found that the a combination similar to Composition 3 performed the best results. We used the product Paraloid EXL2602. All mechanical and physical tests were conducted under the exact same procedures and specifications as previous Compositions. Results of Composition 11 are listed in the following table with averaged value along with the standard deviation with ( ) marks.

Results of Composition 11 (75 wt. % AS + 20 wt. %
T351 + 5 wt. % Paraloid EXL2602)

| Properties | unit | AS | T351 | Composition 11 |
|---|---|---|---|---|
| Bending strength | MPa | 120 | | 149.82 (2.24) |
| Bending modulus | MPa | 3600 | | 7220.38 (18.30) |
| Notched Charpy strength | kJ/m² | 2 | | 7.01 (0.36) |
| Total light transmittance | % | 90 | | 71.22 (0.92) |
| Refractive index | | 1.57 | 1.56 | |

Accordingly, it was found that incorporating of core-shell type additive to glass fiver reinforced polymeric resins is very effective while keeping the clear appearance.

Advanced surface modification technologies can be employed onto plastics surfaces (regardless of fuel-originated plastics or plant-originated plastics). These surface altering technologies can be divided into several groups; (1) a group for altering the surface polymeric structure to form a thin layer of carboxylic acid radical, carbonyl radical, carboxyl radical, amino radial, or the like [JP Tokkai 2004-81837], (2) a group for forming a thin metallic oxide film [Y.Oshida, Bioscience and Bioengineering of Titanium Materials, Elsevier UK, 2006; pp. 314-379]. The first group can be accomplished using the conventional plasma treatment, ultraviolet radiation treatment, ozone or corona discharging technique, or high energy high voltage discharge treatment; while the second group modification can be done by advanced technologies should including PI³ (plasma immersion ion implantation), ECR (electron cyclotron resonance) sputtering, or KECD (kinetic energy control deposition). With these techniques, a thin film of metallic oxides (for example, MgO, TiO₂, or Al₂O₃B₂O₃) or other types of organic or inorganic particles can be deposited onto transparent plastic surfaces. As a result, plastic brackets can be not only more chemically reactive, but also enhanced with surface hardness and strength and, at the same time, can have a reduced value of friction coefficient against the orthodontic archwires.

Composition 12

As one method of many possible surface treatments, surface coating method was applied to reinforced resin material. AS resin matrix was reinforced with 10% and 20% by weight of glass fiber filament (GF FT2A (Products: Owens Corning Japan) with average diameter of 6 μm). These composites were also subjected to the surface treatment. The surface treatment was done by the following sequences; (1) straight coating of polyacrylic emulsion (TT153C: Daicel FineChem, Ltd., Tokyo Japan), (2) letting water drying (120° C., 3 min), (3) and polymerizing remaining acrylic resin to produced the surface hardened layer. All mechanical and physical tests were conducted under the exact same procedures and specifications as previous Compositions. Results of Composition 12 are listed in the following table with averaged value along with the standard deviation with ( ) marks.

Results of Composition 12 (AS + 10 and 20 wt. % GF)
with and without surface treatment

| | | | | Composition 12 | |
|---|---|---|---|---|---|
| | | AS-10 GF | AS-20 GF | AS-10 GF | AS-20 GF |
| property | unit | without treatment | | with treatment | |
| Bending strength | MPa | 129.33 | 149.29 | 134.66 | 155.4 |
| | | (2.32) | (4.2) | (3.02) | (3.30) |
| Bending modulus | MPa | 5370.22 | 7940 | 5460 | 8780 |
| | | (36.09) | (40.12) | (42.22) | (29.09) |
| Notched Charpy | kJ/m² | 3.43 | 4.12 | 4.87 | 5.08 |
| rength | | (0.39) | (0.49) | (0.23) | (0.29) |
| Total light | % | 91.33 | 77.44 | 89.12 | 75.22 |
| transmittance | | (0.13) | (0.15) | (0.22) | (0.30) |

Composition 13

Using the same resin matrix material (Thermoplastic cyclo-olefin copolymer TCOC: Product: TOPAS 5013; Daicel Polymer, Ltd., Tokyo Japan) as for Composition 4, GF FT2A (fiber diameter of 6 μm) was mixed with amount of 5 weight %. The mechanical properties with and without subsequent surface hardening were compared. All mechanical and physical tests were conducted under the exact same procedures and specifications as previous Compositions. Results of Composition 13 are listed in the following table with averaged value along with the standard deviation with ( ) marks.

Results of Composition 13 (TCOC + 10 and 20 wt. % GF)
with and without surface treatment

| | | | Composition 13 |
|---|---|---|---|
| | | TCOC-5GF | TCOC-5GF |
| Property | unit | without treatment | with treatment |
| Bending strength | MPa | 112.45 (3.99) | 109.89 (4.11) |
| Bending modulus | MPa | 3440.88 (29.29) | 3991.83 (29.09) |
| Notched Charpy strength | kJ/m2 | 4.24 (0.88) | 6.12 (0.69) |
| Total light transmittance | % | 94.23 (0.19) | 92.22 (2.03) |

From the above Compositions 16 and 17, it was found that even simple method of surface spray coating improved the mechanical properties of resin-matrix composites.

It is to be understood that various changes and modifications may be made from the compositions discussed above without departing from the scope of the present invention, which is defined by the following claims.

What is claimed:

1. An orthodontic bracket made of polymeric resin being incorporated with reinforcing filler material wherein said polymeric resin is ranged from 30% to 95% by weight and filler material is ranged from 5% to 70% by weight.

2. An orthodontic bracket made of resin-based composite material comprising the polymeric resin being ranged from 60% to 95% by weight and reinforcing filler material being in a range from 5% to 40% by weight.

3. The orthodontic bracket cited in claim 1 wherein polymeric resin is thermoplastic resin.

4. The orthodontic bracket cited in claim 1 wherein polymeric resin is thermosetting resin.

5. The orthodontic bracket cited in claim 1 wherein the reinforcing filler material is organic material.

6. The orthodontic bracket cited in claim 1 wherein the reinforcing filler material is inorganic material.

7. An orthodontic bracket made of polymeric resin being incorporated with reinforcing filler material wherein said polymer resin has more than 70% of total light transmittance for 3 mm thick plate and the refractive index N_{P} with a range from 1.45 to 1.65, and said filler material has refractive index N_{F} with a range from 1.5 to 1.65.

8. The orthodontic bracket cited in claim 7 wherein the reinforced polymeric resin matrix having the resultant total light transmittance of higher than 20% for 3 mm thick plate, and the absolute value of differences in refractive indices between N_{P} and N_{F} less than 0.1.

9. The orthodontic bracket cited in claim 7 wherein the absolute value of differences in refractive indices between N_{P} and N_{F} less than 0.05.

10. The orthodontic bracket cited in claims 1 and 7 wherein the reinforcing filament is either filer-shaped or whisker-shaped filament and possesses the aspect ratio more 10.

11. The orthodontic bracket cited in claims 1 and 7 wherein the reinforcing filament has a weight average fiber length ranging from 0.1 mm to 1 mm.

12. An orthodontic bracket made of polymeric resin being incorporated with reinforcing fine particle material wherein said polymeric resin is ranged from 75% to 95% by weight and fine particle material is ranged from 5% to 25% by weight.

13. The orthodontic bracket cited in cited in claims 12 wherein the reinforcing fine particles has an average particle diameter being equal to or less than visual light wavelength.

14. The orthodontic bracket cited in claim 12 wherein the reinforcing fine particles size is ranged from 1 to 100 nm.

15. The orthodontic bracket cited in claim 12 wherein the reinforcing fine particles are metallic oxide particles.

16. The orthodontic bracket cited in claims 1, 7 and 12 wherein the polymeric resin is biomass polymeric resin.

17. An orthodontic bracket made of polymeric resin whose surface region is treated to enhance its reactivity and its strength and wear resistance and to reduce friction coefficient.

18. The orthodontic bracket cited in claims 1, 2, 7 and 17 wherein, the polymeric resin is a treatable-type UV hardening resins.

19. The orthodontic bracket cited in claims 1, 2, 7 and 17 wherein, the polymeric resin is a treatable-type mixture of thermoplastic and UV hardening resins.

20. The orthodontic bracket cited in claim 17 wherein, prior to surface treatment, the polymeric resin is reinforced with filler filament or fine particle material.

21. The orthodontic bracket cited in claim 17 wherein the polymeric resin is thermoplastic resin.

22. The orthodontic bracket cited in claim 17 wherein the polymeric resin is thermosetting resin.

23. The orthodontic bracket cited in claim 17 wherein the polymeric resin is biomass resin.

24. The orthodontic bracket cited in claim 7 where the polymeric resin is at least one member selected from the group consisting a polystyrene resin, an acrylonitrile-styrene copolymer resin, an acrylonitrile-budadiene-styrene copolymer resin, a styrene-methacrylate copolymer resin, an olefin-base resin, a polyamide-base resin, acryl-base resin, polypropylene polymer, and cyclic olefin polymer.

25. The orthodontic bracket cited in claim 7 wherein the polymeric resin comprising 60-99 weight % of thermoplastic resin and 1-40 weight % of core-shell type impact modifier.
